(19) United States
(12) Patent Application Publication
(10) Pub. No.: US 2022/0263065 A1
(43) Pub. Date: Aug. 18, 2022

(54) MATERIAL FOR NEGATIVE ELECTRODE ACTIVE MATERIAL LAYER, ALL-SOLID-STATE RECHARGEABLE BATTERY INCLUDING THE SAME, AND CHARGING METHOD OF THE BATTERY

(71) Applicant: SAMSUNG SDI CO., LTD., Yongin-si (KR)

(72) Inventors: Naoki SUZUKI, Yokohama-shi (JP); Satoshi FUJIKI, Yokohama-shi (JP)

(21) Appl. No.: 17/582,287

(22) Filed: Jan. 24, 2022

(30) Foreign Application Priority Data
Feb. 17, 2021 (JP) 2021-023732
Jun. 28, 2021 (KR) 10-2021-0084112

(51) Int. Cl. H01M 4/36; H01M 4/133; H01M 4/134; H01M 10/44

(52) U.S. Cl. CPC H01M 4/364; H01M 4/133; H01M 2004/027; H01M 10/44; H01M 4/134

(57) ABSTRACT

A material for a negative electrode active material layer, an all-solid-state rechargeable battery, and a charging method thereof, the material including amorphous carbon, a first element that forms an alloy or compound with lithium by an electrochemical reaction, and a second element that does not form an alloy or compound with lithium by an electrochemical reaction, wherein the second element is an element belonging to the fourth period and Groups 3 to 11 of the periodic table.

### CROSS-REFERENCE TO RELATED APPLICATIONS

This application claims priority to and the benefit of Japanese Patent Application No. 2021-023732 filed in the Japan Patent Office on Feb. 17, 2021, and Korean Patent Application No. 10-2021-0084112 filed in the Korean Intellectual Property Office on Jun. 28, 2021, the entire contents of which are incorporated herein by reference.

BACKGROUND

### 1. Field

Embodiments relate to a material for a negative electrode active material layer, an all-solid-state rechargeable battery including the same, and a charging method of the battery.

### 2. Description of the Related Art

An all-solid-state rechargeable battery using lithium as a negative electrode active material may use lithium deposited in a negative electrode layer by charging as the active material.

### SUMMARY

The embodiments may be realized by providing a material for a negative electrode active material layer, the material including amorphous carbon, a first element that forms an alloy or compound with lithium by an electrochemical reaction, and a second element that does not form an alloy or compound with lithium by an electrochemical reaction, wherein the second element is an element belonging to the fourth period and Groups 3 to 11 of the periodic table.

The second element may be iron, copper, titanium, or nickel.

The amorphous carbon may be carbon black.

The first element may be silver, platinum, gold, or palladium.

The first element may be silver.

In the negative electrode active material layer, a content of the second element may be greater than or equal to about 8 parts by weight and less than or equal to about 50 parts by weight, based on 100 parts by weight of the amorphous carbon.

The embodiments may be realized by providing an all-solid-state rechargeable battery including a positive electrode layer, a negative electrode layer, and a solid electrolyte layer, wherein the negative electrode layer includes a negative electrode active material layer including the material for a negative electrode active material layer according to an embodiment.

An initial charging capacity of the positive electrode layer and an initial charging capacity of the negative electrode layer may satisfy the requirements of Formula (1):

0.01<b/a<0.5 [Formula (1)]

in Formula (1), a is the initial charging capacity, in mAh, of the positive electrode layer and b is the initial charging capacity, in mAh, of the negative electrode layer.

The embodiments may be realized by providing a charging method for an all-solid-state rechargeable battery, wherein the method includes charging the all-solid-state rechargeable battery according to an embodiment beyond the initial charging capacity of the negative electrode layer.

Charging may be performed in a range of about 2 times to about 100 times the initial charging capacity of the negative electrode layer.

### BRIEF DESCRIPTION OF THE DRAWINGS

Features will be apparent to those of skill in the art by describing in detail exemplary embodiments with reference to the attached drawings in which:

FIG. 1 is a cross-sectional view of a schematic configuration of an all-solid-state rechargeable battery according to an embodiment.

FIG. 2 is a cross-sectional view of a schematic configuration of an all-solid-state rechargeable battery according to another embodiment.

FIG. 3 is a cross-sectional view of a schematic configuration in which a lithium metal layer is deposited in the all-solid-state rechargeable battery according to the present embodiment.

FIG. 4 is a cross-sectional view of a schematic configuration in which a lithium metal layer is deposited in the all-solid-state rechargeable battery according to the present embodiment.

FIG. 5 is a cross-sectional view of a schematic configuration of an all-solid-state rechargeable battery according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

### 1. Basic Configuration of All-solid-state Rechargeable Battery According to the Present Embodiment

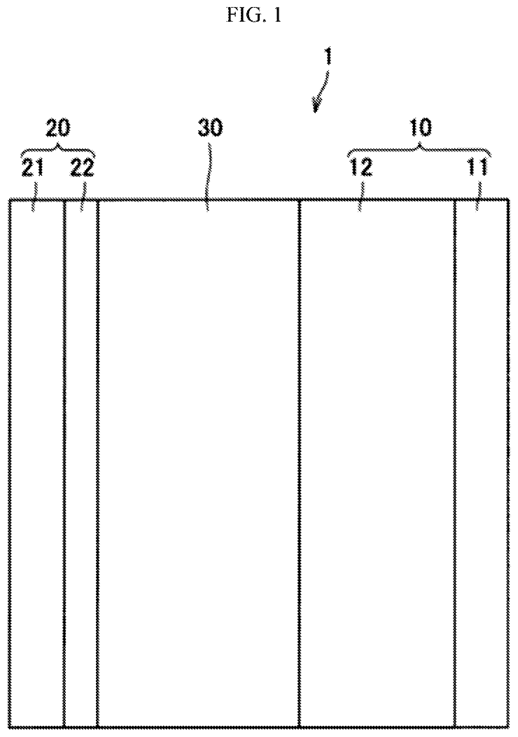

As shown in FIG. 1, the all-solid-state rechargeable battery 1 according to the present embodiment may include a positive electrode layer 10, a negative electrode layer 20, and a solid electrolyte layer 30.

(1-1. Positive Electrode Layer)

The positive electrode layer 10 may include a positive electrode current collector 11 and a positive electrode active material layer 12. Examples of the positive electrode current collector 11 may include a plate or thin body made of indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. As used herein, the term “or” is not an exclusive term, e.g., “A or B” would include A, B, or A and B. In an implementation, the positive electrode current collector 11 may be omitted.

The positive electrode active material layer 12 may include a positive electrode active material and a solid electrolyte. In an implementation, the solid electrolyte contained in the positive electrode active material layer 12 may or may not be of the same type as the solid electrolyte contained in the solid electrolyte layer 30. The details of the solid electrolyte will be described in detail in the section of the solid electrolyte layer 30.

The positive electrode active material may be a suitable positive electrode active material capable of reversibly intercalating and deintercalating lithium ions. In an implementation, the positive electrode active material may include a lithium compound or lithium salt (such as lithium cobalt oxide (hereinafter, referred to as “LCO”), lithium nickel oxide, lithium nickel cobalt oxide, and lithium nickel cobalt aluminate (hereinafter referred to as “NCA”), lithium nickel cobalt manganate (hereinafter referred to as “NCM”), lithium manganate, or lithium iron phosphate); nickel sulfide, copper sulfide, lithium sulfide, sulfur, iron oxide; vanadium oxide, or the like. These positive electrode active materials may be used alone, respectively, and may be used in combination of two or more.

In an implementation, the positive electrode active material may be formed by including a lithium compound or salt of a transition metal oxide having a layered rock salt structure among the aforementioned lithium salts. Herein, the “layered rock salt structure” is a structure in which oxygen atomic layers and metal atomic layers are alternately arranged in the <111>direction of the cubic rock salt structure, and as a result, each atomic layer forms a two-dimensional plane. In addition, “cubic rock salt structure” refers to a sodium chloride type structure, which is one type of crystal structure, and specifically, a structure in which the face-centered cubic lattice formed by each of the cations and anions is arranged with a shift of only ½ of the corners of the unit lattice from each other.

Examples of the lithium salt of the transition metal oxide having such a layered rock salt structure may include lithium salts of ternary transition metal oxides such as LiNiₓCo_{y}Al_{z}O₂(NCA) or LiNiₓCo_{y}Mn_{z}O₂(NCM)(0<x<1, 0<y<1, 0<z<1, and x+y+z=1). When the positive electrode active material includes a lithium salt of a ternary transition metal oxide having the aforementioned layered rock salt structure, the energy density and thermal stability of the all-solid-state rechargeable battery 1 may be improved.

In an implementation, the positive electrode active material may be covered with a coating layer. Herein, the coating layer of this embodiment may be a suitable coating layer for a positive electrode active material of an all-solid-state rechargeable battery. Examples of the coating layer may include Li₂O—ZrO₂ and the like.

In an implementation, the positive electrode active material may be formed from a lithium salt of a ternary transition metal oxide such as NCA or NCM, nickel (Ni) may be included as the positive electrode active material, and the coating layer may increase capacity density of the all-solid-state rechargeable battery 1, and may reduce metal elution from the positive electrode active material in a charged state. Accordingly, the all-solid-state rechargeable battery 1 according to the present embodiment may help improve long-term reliability and cycle characteristics in a charged state.

In an implementation, the positive electrode active material may have a shape of a particle, e.g., a regular spherical shape or an ellipsoidal shape. In an implementation, the particle diameter (e.g., D50 or average particle diameter) of the positive electrode active material may be within a range suitable for a positive electrode active material of an all-solid-state rechargeable battery. In an implementation, a content of the positive electrode active material in the positive electrode layer 10 may be within a range suitable for a positive electrode layer 10 of an all-solid rechargeable battery.

In an implementation, in the positive electrode layer 10, in addition to the aforementioned positive electrode active material and solid electrolyte, e.g., additives such as a conductive auxiliary agent, a binder material, a filler, a dispersant, or an ion conductive auxiliary agent may be suitably blended or included.

Examples of the conductive auxiliary agent that may be blended in the positive electrode layer 10 may include graphite, carbon black, acetylene black, ketjen black, a carbon fiber, and a metal powder. In an implementation, the binder that may be blended in the positive electrode layer 10 may include, e.g., a styrene butadiene rubber (SBR), polytetrafluoroethylene, polyvinylidene fluoride, polyethylene, or the like. In an implementation, as the filler, the dispersant, the ion conductive auxiliary agent, or the like, which may be blended in the positive electrode layer 10, suitable materials for the electrode of an all-solid-state rechargeable battery may be used.

(1-2. Negative Electrode Layer)

The negative electrode layer 20 may include a negative electrode current collector 21 and a negative electrode active material layer 22. The negative electrode current collector 21 may be made of a material that does not react with lithium, e.g., neither an alloy nor a compound is formed. Examples of the material constituting the negative electrode current collector 21 may include copper (Cu), stainless steel, titanium (Ti), iron (Fe), cobalt (Co), and nickel (Ni). The negative electrode current collector 21 may be composed of any one of these metals, or may be composed of an alloy of two or more metals or a clad material. The negative electrode current collector 21 may be, e.g., a plate or thin type.

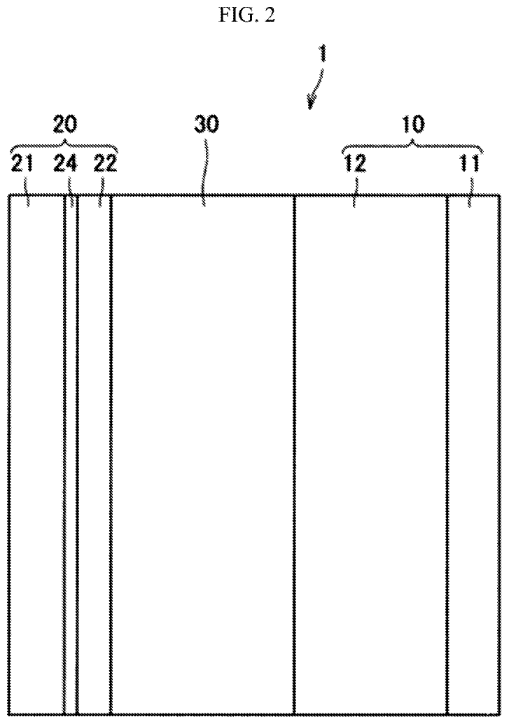

In an implementation, as shown in FIG. 2, a thin film 24 may be formed on the surface of the negative electrode current collector 21. The thin film 24 may include an element capable of forming an alloy with lithium. The element may include, e.g., gold, silver, zinc, tin, indium, silicon, aluminum, bismuth, or the like. The thin film 24 may include one type of these metals, and may be comprised by or include several types of alloys. Due to the presence of the thin film 24, the deposition shape of the metal layer 23 may be more planarized, and the characteristics of the all-solid-state rechargeable battery 1 may be further improved.

In an implementation, the thickness of the thin film 24 may be greater than or equal to about 1 nm and less than or equal to about 500 nm. Maintaining the thickness of the thin film 24 at about 1 nm or greater may help ensure that the function of the thin film 24 may be sufficiently exhibited. Maintaining the thickness of the thin film 24 at about 500 nm or less may help prevent a decrease in a lithium deposition amount on the negative electrode due to the lithium intercalation of the thin film 24 itself, and thus deterioration of the characteristics of the all-solid-state rechargeable battery 1 may be prevented. The thin film 24 may be formed on the negative electrode current collector 21 by, e.g., a vacuum deposition method, a sputtering method, or a plating method.

The negative electrode active material layer 22 may include a negative electrode active material that forms an alloy or compound with lithium. In an implementation, a comparison between or a ratio of a charge capacity of the positive electrode active material layer 12 and a charge capacity of the negative electrode active material layer 22, e.g., a capacity ratio, may satisfy the requirements of Formula (1).

0.01<b/a<0.5 [Formula (1)]

In Formula (1), a is the charge capacity (in mAh) of the positive active material layer 12, and b is the charge capacity (in mAh) of the negative electrode active material layer 22.

In an implementation, the charge capacity of the positive active material layer 12 may be obtained by multiplying a charge capacity density (mAh/g) of the positive active material by a mass of the positive active material in the positive active material layer 12. When a plurality of the positive active materials is used, density x mass of each positive active material may be calculated, and a sum thereof may be used as the charge capacity of the positive active material layer 12. The charge capacity of the negative electrode active material layer 22 may be obtained according to the same method.

In an implementation, the charge capacity of the negative electrode active material layer 22 may be obtained by multiplying a charge capacity density (mAh/g) of the negative electrode active material by a mass of the negative electrode active material in the negative electrode active material layer 22. When a plurality of the negative electrode active materials is used, charge capacity (density×mass) of each negative electrode active material may be calculated, and a sum thereof may be used as the capacity of the negative electrode active material layer 22. In an implementation, the charge capacity densities of the positive and negative electrode active materials may be estimated using an all-solid half-cell using a lithium metal for the counter electrode. In an implementation, the charge capacities of the positive active material layer 12 and the negative electrode active material layer 22 may be directly measured by using the all-solid half-cell.

A specific method of directly measuring the charge capacities may be the following method. First of all, the charge capacity of the positive active material layer 12 may be measured by manufacturing a test cell using the positive active material layer 12 as a working electrode and Li as the counter electrode and then, performing a CC-CV charge from OCV (open voltage) to an upper limit charge voltage. The upper limit charge voltage is set according to the standard of JIS C 8712:2015, which indicates 4.25 V for a lithium cobalt acid-based positive electrode and for the other positive electrodes, a voltage required according to A. 3.2.3 (safety requirements when other upper limit charge voltages are applied) of JIS C 8712:2015. The charge capacity of the negative electrode active material layer 22 may be measured by producing a test cell using the negative electrode active material layer 22 as a working electrode and Li as the counter electrode and then, performing a CC-CV charge from OCV (open voltage) to 0.01 V.

The aforementioned test cell may be, e.g., produced in the following method. The positive active material layer 12 or the negative electrode active material layer 22 for the charge capacity measurement may be punched out in a disk shape with a diameter of 13 mm. An electrolyte pellet with a diameter of about 13 mm and a thickness of about 1 mm may be prepared by molding about 200 g of the same solid electrolyte powder as used in the all-solid-state rechargeable battery at about 40 MPa. The pellet may be put in a tube with an inner diameter of about 13 mm, the positive electrode active material layer 12 or the negative electrode active material layer 22 punched out in the disk shape may be put from one side, and a lithium foil with a diameter of about 13 mm and a thickness of about 0.03 mm may be put from the other side. In an implementation, after inserting each one stainless steel disk from both sides of the tube, the whole tube may be pressurized to integrate the contents at 300 MPa in the axial direction for about 1 minute. The integrated contents may be taken from the tube and put in a case so that a pressure of about 22 MPa is always applied thereto, and the case is sealed, completing the test cell. The charge capacity of the positive active material layer 12 may be measured by CC-charging the test cell, e.g., at current density of about 0.1 mA and CV-charging it to about 0.02 mA.

The charge capacity is divided by the mass of each active material to calculate charge capacity density. Initial charge capacities of the positive electrode active material layer 12 and the negative electrode active material layer 22 may be initial charge capacities at the 1^{st} cycle charge. These values are used in examples described below.

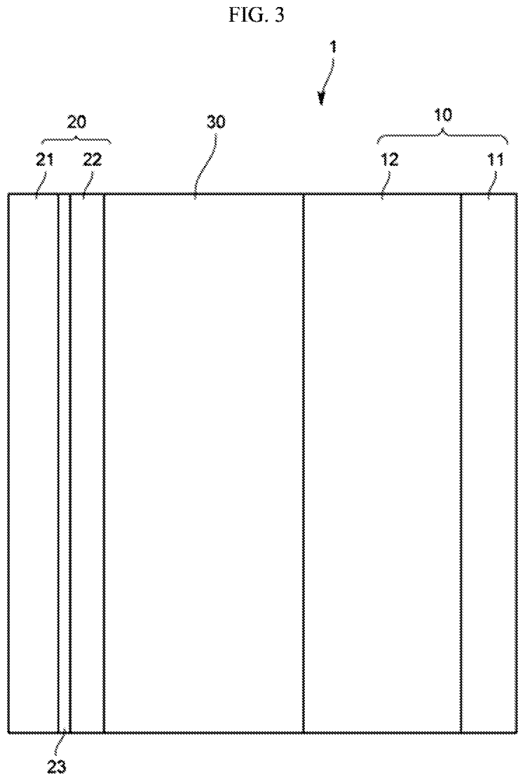

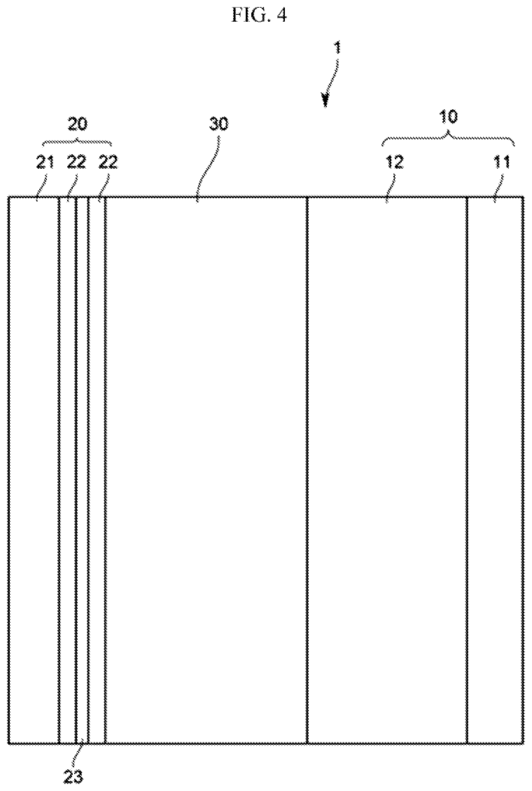

In an implementation, the charging capacity of the positive electrode active material layer 12 may be excessive with respect to the charging capacity of the negative electrode active material layer 22. As will be described below, in the present embodiment, the all-solid-state rechargeable battery 1 may be charged beyond the charging capacity of the negative electrode active material layer 22. In an implementation, the negative electrode active material layer 22 may be overcharged. In the initial stage of charging, lithium may be intercalated in the negative electrode active material layer 22. In an implementation, the negative electrode active material may form an alloy or compound with lithium ions that have migrated from the positive electrode layer 10. When charging is performed beyond the charging capacity of the negative electrode active material layer 22, e.g., as shown in FIG. 3, on the rear surface of the negative electrode active material layer 22, e.g., between the negative electrode current collector 21 and the negative electrode active material layer 22, lithium may be deposited, and the metal layer 23 may be formed of this lithium. In an implementation, the metal layer 23 may be, e.g., formed inside the negative electrode active material layer 22 as shown in FIG. 4. In an implementation, the metal layer 23 may be formed so as to be sandwiched between the negative electrode active material layer 22 divided into two sheets. The metal layer 23 may be mainly composed of lithium (i.e., metal lithium). This phenomenon may be caused by the negative electrode active material including a specific material, e.g., an element that forms an alloy or compound with lithium.

During discharging, lithium in the negative electrode active material layer 22 and the metal layer 23 may be ionized and move to the positive electrode layer 10. Therefore, in the all-solid-state rechargeable battery 1, lithium may be used as a negative electrode active material. In addition, the negative electrode active material layer 22 may cover the metal layer 23, and the negative electrode active material layer 22 may be a protective layer of the metal layer 23, and may help suppress precipitation and growth of dendrites. Thus, a short circuit and capacity reduction of the all-solid-state rechargeable battery 1 may be suppressed, and characteristics of the all-solid-state rechargeable battery 1 may be improved.

In an implementation, the capacity ratio may be greater than about 0.01. Maintaining the capacity ratio at about 0.01 or greater may help prevent characteristics of the all-solid-state rechargeable battery 1 from being deteriorated. The negative electrode active material layer 22 may not sufficiently function as a protective layer. If the thickness of the negative electrode active material layer 22 were to be very thin, the capacity ratio may be less than or equal to about 0.01. In this case, the negative electrode active material layer 22 could collapse due to repeated charging and discharging, and dendrites may be precipitated and grown. As a result, the characteristics of the all-solid-state rechargeable battery 1 may be deteriorated. In some other batteries, an interfacial layer or carbon layer may also be too thin, and the characteristics of the all-solid-state rechargeable battery may not be sufficiently improved.

In an implementation, the capacity ratio may be less than about 0.5. Maintaining the capacity ratio at about 0.5 or less may help prevent a decrease in the amount of lithium precipitated in the negative electrode, thereby maintaining the battery capacity. In an implementation, the capacity ratio may be less than about 0.25. In an implementation, when the capacity ratio is less than about 0.25, the output characteristic of a battery may also be improved.

The negative electrode active material layer 22 for realizing the above-described function may include, e.g., a negative electrode active material including amorphous carbon and a first element. The amorphous carbon may include, e.g., carbon black, graphene, or the like. Examples of the carbon black may include acetylene black, furnace black, ketjen black, and the like. In an implementation, the first element may be an element that forms an alloy or compound with lithium, and may be, e.g., gold, platinum, palladium, or silver.

When gold, platinum, palladium, or silver is used as the first element, the negative electrode active materials may have, e.g., a particle shape, and the particle diameter thereof may be, e.g., less than or equal to about 4 μm, or less than or equal to about 300 nm. In this case, the characteristics of the all-solid-state rechargeable battery 1 may also be improved. Herein, the particle size of the negative electrode active material may be, e.g., a median or average diameter (D50) measured using a laser particle size distribution meter. In the following Examples and Comparative Examples, the particle size was measured by this method. In an implementation, the lower limit of the particle size may be, e.g., 10 nm.

In an implementation, the negative electrode active material layer 22 may include the binder. Examples of the binder may include a styrene butadiene rubber (SBR), polytetrafluoroethylene, polyvinylidene fluoride, and polyethylene. The binder may include one type or at least two types.

By including the binder in the negative electrode active material layer 22, the negative electrode active material layer 22 may be stabilized on the negative electrode current collector 21. If the binder were not included in the negative electrode active material layer 22, the negative electrode active material layer 22 could be easily separated from the negative electrode current collector 21. The negative electrode current collector 21 may be exposed where the negative electrode active material layer 22 is separated from the negative electrode current collector 21, and a short circuit could occur. In an implementation, as will be described in greater detail below, the negative electrode active material layer 22 may be formed by coating slurry in which materials constituting the negative electrode active material layer 22 are dispersed and then, drying it. The binder may be included in the negative electrode active material layer 22 to stably disperse the negative electrode active material in the slurry. As a result, when the slurry is coated, e.g., using a screen printing method, on the negative electrode current collector 21, clogging of a screen may be suppressed (e.g., clogging by agglomerates of the negative electrode active material may be suppressed).

In an implementation, when the binder is included in negative electrode active material layer 22, a content of the binder may be greater than or equal to about 0.3 wt % and less than or equal to about 15 wt %, based on the total weight of the negative electrode active material. Maintaining the content of the binder at about 0.3 wt % or greater may help ensure that the strength of the film is sufficient, and the properties are not deteriorated, thereby facilitating handling. Maintaining the content of the binder at about 20 wt % or less may help ensure that the properties of the all-solid-state rechargeable battery 1 are not deteriorated. In an implementation, an upper limit of the content of the binder may be about 3 wt %.

In an implementation, thickness of the negative electrode active material layer 22 may satisfy the requirements of Formula (1), e.g., may be greater than or equal to about 1 μm and less than or equal to about 20 μm. Maintaining the thickness of the negative electrode active material layer 22 at about 1 μm or greater may help ensure that the characteristics of the all-solid-state rechargeable battery 1 are sufficiently improved. Maintaining the thickness of the negative electrode active material layer 22 at about 20 μm or less may help prevent an increase in a resistance value of the negative electrode active material layer 22, and may help ensure that the characteristics of the all-solid-state rechargeable battery 1 are sufficiently improved. The thickness of the negative electrode active material layer 22 may be estimated by, e.g., assembling an all-solid-state rechargeable battery and observing a cross section after pressure formation with a scanning electron microscope (SEM).

In the negative electrode active material layer 22, a suitable additive for all-solid rechargeable batteries, e.g., a filler, a dispersant, an ion conductive agent, or the like may be appropriately blended.

(1-3. Solid Electrolyte Layer)

The solid electrolyte layer 30 may be between the positive electrode layer 10 and the negative electrode layer 20 and may include a solid electrolyte.

The solid electrolyte may be composed of, e.g., a sulfide solid electrolyte material. The sulfide solid electrolyte material may include, e.g., Li₂S—P₂S₅,Li₂S—P₂S—LiX (in which X is a halogen element, e.g., I, or Cl), Li₂S—P₂S₅—Li₂O, Li₂S—P₂S₅Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are integers and Z is Ge, Zn, or Ga), Li₂S—GeS₂, Li₂S—SiS₂—Li₃PO₄, Li₂S—SiS₂—LiₚMO_{q} (in which p and q are integers and M is P, Si, Ge, B, Al, Ga, or In). In an implementation, the sulfide solid electrolyte material may be produced by treating a starting raw material (e.g., Li₂S, P₂S₅, or the like) by a melt quenching method, a mechanical milling method, or the like. In an implementation, heat treatment may be further performed. The solid electrolyte may be amorphous or crystalline, or may be in a mixed state thereof.

In an implementation, the solid electrolyte may be one containing at least sulfur (S), phosphorus (P) and lithium (Li) as constituent elements among the above sulfide solid electrolyte materials, e.g., Li₂S—P₂S₅. In an implementation, when using one containing Li₂S—P₂S₅ as the sulfide solid electrolyte material forming the solid electrolyte, a mixing mole ratio of Li₂S and P₂S₅ may be, e.g., in the range of Li₂S:P₂S₅=about 50:50 to about 90:10.

In an implementation, the solid electrolyte layer 30 may further include a binder. The binder included in the solid electrolyte layer 30 may include, e.g., a styrene butadiene rubber (SBR), polytetrafluoroethylene, polyvinylidene fluoride, polyethylene, or the like. The binder in the solid electrolyte layer 30 may be the same as or different from the binder in the positive electrode active material layer 12 and the negative electrode active material layer 22.

Examples of an oxide solid electrolyte may include garnet-type composite oxide, perovskite-type oxide, LISICON-type composite oxide, NASICON-type composite oxide, Li-alumina-type composite oxide, LiPON, and oxide glass. Among these oxide-based solid electrolytes, an oxide solid electrolyte may be used stably even with respect to lithium metal. In an implementation, it may include La_{0.51}Li_{0.34}Ti_{02.94,} Li_{1.3}Al_{10.3}Ti_{1.7}(PO₄)₃, Li₇La₃Zr₂O₁₂, 50Li₄SiO₄.50Li₃BO₃, Li_{2.9}PO_{3.3}N, Li_{3.6}Si_{0.6}P_{0.4}O₄, Li_{1.07}Al_{0.69}Ti_{1.46}(PO₄)₃, or Li_{1.5}Al_{10.5}Ge_{1.5}(PO₄)₃.

### 2. Characteristic Configuration of All-Solid-State Rechargeable Battery According to the Present Embodiment

The negative electrode active material layer 22 may further include a second element that does not form an alloy or compound with lithium. The second element may be an element belonging to or in the fourth period, and belonging to or in Groups 3 to 11 of the element periodic table (e.g., scandium, titanium, vanadium, chromium, manganese, iron, cobalt, nickel, or copper). In an implementation, the second element may be, e.g., iron, copper, nickel, or titanium. Any one of them may be used or a plurality of types from these may be used in combination. These second elements may be in the form of granules, and although a suitable average primary particle diameter (D50) is different according to each element, it may be, e.g., greater than or equal to about 20 nm and less than or equal to about 1,000 nm, or greater than or equal to about 65 nm and less than or equal to about 800 nm, or greater than or equal to about 50 nm and less than or equal to about 100 nm measured by laser diffraction.

A content of the amorphous carbon included in the negative electrode active material layer 22 may be greater than or equal to about 33 parts by weight and less than or equal to about 95 parts by weight, when a content of the negative electrode active material (in the present embodiment, the total content of the amorphous carbon and the first element) is 100 parts by weight (e.g., based on 100 parts by weight of the negative electrode active material). A content of the first element may be greater than or equal to about 10 parts by weight and less than or equal to about 25 parts by weight, and desirably greater than or equal to about 15 parts by weight and less than or equal to about 20 parts by weight, when the content of the amorphous carbon included in the negative electrode active material layer 22 is 100 parts by weight. A content of the second element may be greater than or equal to about 8 parts by weight and less than or equal to about 50 parts by weight, or greater than or equal to about 16 parts by weight and less than or equal to about 50 parts by weight, when the content of the amorphous carbon included in the negative electrode active material layer 22 is 100 parts by weight.

The material for the negative electrode active material layer 22 may include:
50 wt % to 90 wt % of the amorphous carbon,
5 wt % to 20 wt % of the first element, and
5 wt % to 40 wt % of the second element based on 100 wt % of the material.

A weight ratio of the amorphous carbon to the first element may be in the range of 5:1 to 7:1, especially 6:1. A weight ratio of the amorphous carbon to the second element may be in the range of 1.5:1 to 15:1, preferably 1.5:1 to 3:1, especially 2:1. A weight ratio of the first element to the second element may be in the range of 1:4 to 3:1, preferably 1:4 to 1:2, especially 1:3.

### 3. Method of Producing All-Solid-State Rechargeable Battery According to the Present Embodiment

Next, a method of producing the all-solid-state rechargeable battery 1 according to on the present embodiment is described. The all-solid-state rechargeable battery 1 according to the present embodiment may be produced by respectively producing the positive electrode layer 10, the negative electrode layer 20, and the solid electrolyte layer 30, and laminating each layer.

(3-1. Production Process of Positive Electrode Layer)

First, materials (a positive electrode active material, a binder, and the like) constituting the positive electrode active material layer 12 may be added to a non-polar solvent to prepare slurry (the slurry may be a paste and other slurry is also the same.). Then, the obtained slurry may be applied on the positive electrode current collector 11 and dried. Then, the positive electrode layer 10 may be produced by pressurizing the obtained laminate (e.g., performing pressurization using hydrostatic pressure). In an implementation, the pressurization process may be omitted. The positive electrode layer 10 may be produced by pressing/compressing a mixture of materials constituting the positive electrode active material layer 12 in a pellet form, or stretching it in a sheet form. When the positive electrode layer 10 is produced by these methods, the positive electrode current collector 11 may be compressed on the produced pellet or sheet.

(3-2. Production Process of Negative Electrode Layer)

First, the negative electrode active material layer materials (a negative electrode active material, a first element, a second element, a binder, and the like) constituting the negative electrode active material layer 22 may be added to a polar solvent or a non-polar solvent to prepare a slurry. Then, the obtained slurry may be applied on the negative electrode current collector 21 and dried. Then, the negative electrode layer 20 may be produced by pressurizing the obtained laminate (e.g., performing pressurization using hydrostatic pressure). In an implementation, the pressurization process may be omitted.

(3-3. Production Process of Solid Electrolyte Layer)

The solid electrolyte layer 30 may be made of a solid electrolyte formed from a sulfide solid electrolyte material. First, the starting materials may be treated by a melt quenching method or a mechanical milling method. In an implementation, when using the melt quenching method, a predetermined amount of starting materials (e.g., Li₂S, P₂S₅, or the like) may be mixed, the pelletized product may be reacted in a vacuum at a predetermined reaction temperature, and then quenched to produce a sulfide solid electrolyte material. In an implementation, the reaction temperature of the mixture of Li₂S and P₂S₅ may be about 400° C. to about 1,000° C., e.g., about 800° C. to about 900° C. In an implementation, the reaction time may be about 0.1 hour to about 12 hours, e.g., about 1 hour to about 12 hours. In an implementation, the quenching temperature of the reactants may be less than or equal to about 10° C., e.g., less than or equal to about 0° C., and the quenching rate may be about 1° C./sec to about 10,000° C./sec, e.g., about 1° C./sec to about 1,000° C./sec.

In an implementation, when the mechanical milling method is used, a sulfide solid electrolyte material may be produced by stirring and reacting starting materials (e.g., Li₂S, P₂S₅, or the like) using a ball mill or the like. In an implementation, the stirring speed and stirring time in the mechanical milling method may be suitably selected. As the stirring speed is faster, the production rate of the sulfide-based solid electrolyte material may be higher, and as the stirring time is longer, the conversion rate of the raw material into the sulfide solid electrolyte material may be higher. Thereafter, the mixed raw materials obtained by the melt quenching method or the mechanical milling method may be heat-treated at a predetermined temperature and then pulverized to produce a particulate solid electrolyte. When the solid electrolyte has a glass transition point, it may change from amorphous to crystalline by heat treatment.

Subsequently, the solid electrolyte obtained by the above method may be formed into a film using a suitable film forming method such as an aerosol deposition method, a cold spray method, or a sputtering method, thereby producing a solid electrolyte layer 30. In an implementation, the solid electrolyte layer 30 may be produced by pressing solid electrolyte particles block. In an implementation, the solid electrolyte layer 30 may be produced by mixing a solid electrolyte, a solvent, and a binder, applying, drying, and pressurizing.

(3-4. Assembly Process of All-solid-state Rechargeable Battery)

The all-solid-state rechargeable battery 1 according to the present embodiment may be produced by laminating the positive electrode layer 10, the negative electrode layer 20, and the solid electrolyte layer 30 which are produced by the above method so that the solid electrolyte layer 30 may be between the positive electrode layer 10 and the negative electrode layer 20, and pressurizing the same (e.g., performing pressurization using hydrostatic pressure).

When the all-solid-state battery produced by the above method is operated, it may be carried out in a state in which pressure is applied to the all-solid-state battery. The pressure may be greater than or equal to about 0.5 MPa and less than or equal to about 10 MPa.

In an implementation, application of pressure may also be performed by a method, e.g., placing an all-solid-state battery between two hard plates, such as stainless steel, brass, aluminum, glass, and tightening these two plates with a screw.

### 4. Charging Method of All-Solid-State Rechargeable Battery

Next, the charging method of the all-solid-state rechargeable battery 1 is described. In the present embodiment, as described above, the all-solid-state rechargeable battery 1 may be charged beyond the charging capacity of the negative electrode active material layer 22. In an implementation, the negative electrode active material layer 22 is overcharged. In the initial stage of charging, lithium may be intercalated in the negative electrode active material layer 22. When charging is performed beyond the charging capacity of the negative electrode active material layer 22, e.g., as shown in FIG. 3, on the rear surface of the negative electrode active material layer 22, e.g., between the negative electrode current collector 21 and the negative electrode active material layer 22, lithium may be deposited, and the metal layer 23, which is not present at the time of production, may be formed by or from this lithium.

During discharging, lithium in the negative electrode active material layer 22 and the metal layer 23 may be ionized and move to the positive electrode layer 10. In an implementation, the charging amount may be a value between about 2 times and about 100 times, e.g., about 4 times or more and about 100 times or less the charge capacity of the negative electrode active material layer 22.

### 5. Effect of the Present Embodiment

According to the all-solid-state rechargeable battery 1 configured as described above, the negative electrode active material layer 22 may contain amorphous carbon and the first element as a negative electrode active material, and when charged beyond charge capacity of the negative electrode active material, lithium deposition on the surface of the negative electrode active material layer 22 at the solid electrolyte layer 30 which occurs in a battery capable of using lithium as a negative electrode active material may be suppressed.

In an implementation, when the negative electrode active material layer 22 is overcharged, e.g., as shown as the metal layer 23 in FIG. 3 or 4, lithium may be deposited in layers. As a result, compared with when the lithium is not deposited in layers, an internal pressure increase due to charges and discharges in the all-solid-state rechargeable battery 1 may be suppressed. In an implementation, compared with when the lithium is not deposited in layers, generation of internal voids due to the charges and discharges in the all-solid-state rechargeable battery 1 may be suppressed.

For the same reasons as described above, in the all-solid-state rechargeable battery 1 according to the embodiment, deposition and growth of dendrites may be suppressed. Accordingly, in the all-solid-state rechargeable battery, a short circuit and capacity deterioration may be suppressed, and furthermore, characteristics of the all-solid-state rechargeable battery may be improved.

In the all-solid-state rechargeable battery 1 according to the embodiment, the negative electrode active material layer 22 may further include the aforementioned second element, as described above, and the deposition or growth of dendrites may not only be suppressed, but also an amount of a noble metal as the first element included in the negative electrode active material layer 22 may be reduced. As a result, a producing cost of the all-solid-state rechargeable battery 1 may be reduced. In an implementation, in the all-solid-state rechargeable battery 1, the metal layer 23 may not be formed in advance before the first charge, and the producing cost may be further reduced, compared with the all-solid-state rechargeable battery 1 in which the metal layer 23 is formed in advance, e.g., according to the second embodiment.

### 6. Another Embodiment of the Present Disclosure

### 6-1. Configuration of All-Solid-State Rechargeable Battery According to the Second Embodiment

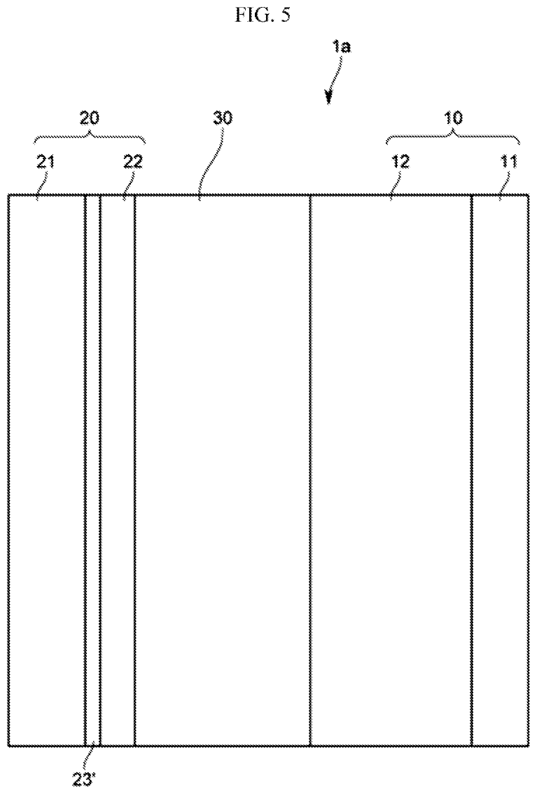

Next, the configuration of the all-solid-state rechargeable battery la according to the second embodiment is described with reference to FIG. 5. As shown in FIG. 5, the all-solid-state rechargeable battery la may include a positive electrode layer 10, a negative electrode layer 20, and a solid electrolyte layer 30. The configurations of the positive electrode layer 10 and the solid electrolyte layer 30 may be the same as those of the first embodiment.

(6-1-1. Configuration of Negative Electrode Layer)

In an implementation, the negative electrode layer 20 may include the negative electrode current collector 21, the negative electrode active material layer 22, and the metal layer 23. In the first embodiment, the metal layer 23 may not exist before the first charging, and may be formed between the negative electrode current collector 21 and the negative electrode active material layer 22 by (e.g., initially) overcharging the negative electrode active material layer 22. In the second embodiment, as shown in FIG. 5, a metal layer 23′ may be formed in advance (e.g., before the first charge) between the negative electrode current collector 21 and the negative electrode active material layer 22. In an implementation, as in the first embodiment, the metal layer 23 may also be further formed by the lithium the deposited in the negative electrode active material layer 22.

The negative electrode current collector 21 and the negative electrode active material layer 22 may have the same configuration as those of the first embodiment. The metal layer 23′ may include lithium or a lithium alloy. In an implementation, the metal layer 23′ may function as a storage for lithium. The lithium alloy may include, e.g., Li-Al alloy, Li—Sn alloy, Li—In alloy, Li—Ag alloy, Li—Au alloy, Li—Zn alloy, Li—Ge alloy, or Li—Si alloy. The metal layer 23′ may be composed of any one of these alloys or the lithium or composed of multiple types of the alloys. In the second embodiment, the metal layer 23′ may function as the lithium storage and thus may improve the characteristics of the all-solid-state rechargeable battery 1.

In an implementation, a thickness of the metal layer 23′ may be in a range of greater than or equal to about 1 μm and less than or equal to about 200 μm. Maintaining the thickness of the metal layer 23′ at about 1 μm or greater may help ensure that the metal layer 23′ sufficiently works as the storage. Maintaining the thickness of the metal layer 23′ at about 200 μm of less may help ensure that the mass and the volume of the all-solid-state rechargeable battery 1 are not increased, thereby avoiding deterioration of the characteristics thereof. In an implementation, the metal layer 23′ may be, e.g., a metal foil having the above thickness.

### Method for Producing All-Solid-State Rechargeable Battery According to the Second Embodiment

Next, the producing method of the all-solid-state rechargeable battery 1 according to second embodiment is described. The positive electrode layer 10 and the solid electrolyte layer 30 may be produced in the same manner as in the first embodiment.

(6-2-1. Production Process of Negative Electrode Layer)

In the second embodiment, the negative electrode active material layer 22 may be disposed on the metal layer 23′. In an implementation, the metal layer 23′ may be, e.g., a metal foil. It may be difficult to form the negative electrode active material layer 22 on the lithium foil or lithium alloy foil, and the negative electrode layer 20 may be produced by the following method.

First, the negative electrode active material layer 22 may be formed on a specific substrate (e.g., Ni plate) by the same method as in the first embodiment. In an implementation, a slurry may be prepared by adding the material constituting the negative electrode active material layer 22 to a solvent. Then, the obtained slurry may be applied on a substrate, and then dried. Next, the negative electrode active material layer 22 may be formed on the substrate by pressurizing the obtained laminate (e.g., performing pressurization using hydrostatic pressure). In an implementation, the pressurization process may be omitted.

Next, the solid electrolyte layer 30 may be laminated on the negative electrode active material layer 22, and the obtained laminate may be pressurized (performing pressurization using hydrostatic pressure). Then, the substrate may be removed. Accordingly, a laminate of the negative electrode active material layer 22 and the solid electrolyte layer 30 may be produced.

Next, on the negative electrode current collector 21, the metal foil constituting the metal layer 23′, the laminate of the negative electrode active material layer 22 and the solid electrolyte layer 30, and the positive electrode layer 10 may be sequentially laminated. Next, the all-solid-state rechargeable battery la may be produced by pressurizing the obtained laminate (e.g., performing pressurization using hydrostatic pressure).

When operating the all-solid-state battery produced by the above method, it may be carried out in a state in which pressure is applied to the all-solid-state battery.

The pressure may be greater than or equal to about 0.5 MPa and less than or equal to about 10 MPa. In an implementation, the application of pressure may also be performed by placing an all-solid-state battery between two hard plates such as stainless steel, brass, aluminum, glass, or the like, and tightening these two plates with screws.

### 6-3. Charging Method of All-Solid-State Rechargeable Battery According to the Second Embodiment

A charging method of the all-solid-state rechargeable battery la may be the same as in the first embodiment. In an implementation, the all-solid-state rechargeable battery la may be charged beyond the charge capacity of the negative electrode active material layer 22. In an implementation, the negative electrode active material layer 22 may be overcharged. At the initial charge, lithium may be intercalated in the negative electrode active material layer 22. When the charging is performed beyond the capacity of the negative electrode active material layer 22, lithium may be deposited in the metal layer 23′ (or on the metal layer 23′). During the discharging, the lithium in the negative electrode active material layer 22 and the metal layer 23′ (or on the metal layer 23) may be ionized and may move toward the positive electrode layer 10.

### 7. Effects of the Second Embodiment

The all-solid-state rechargeable battery la, like in the above embodiment, may use lithium as a negative electrode active material. In an implementation, the negative electrode active material layer 22 may coat the metal layer 23 and may work as a protective layer of the metal layer 23 and simultaneously, may help suppress deposition and growth of dendrites. In an implementation, a short circuit and capacity deterioration of the all-solid-state rechargeable battery la may be suppressed, and the characteristics of the all-solid-state rechargeable battery la may be further improved.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

Examples of the material for the negative electrode active material layer, the negative electrode active material layer produced using the material for the negative electrode active material layer, and the all-solid-state rechargeable battery having the negative electrode active material layer are described as follows.

### 1. DESCRIPTION OF EXAMPLES AND COMPARATIVE EXAMPLES

### Example 1

A negative electrode active material layer was formed using carbon black as amorphous carbon, silver as an alloy forming element, and iron as a non-alloy forming element, and then, charge and discharge characteristics of an all-solid-state rechargeable battery cell having the negative electrode active material layer was evaluated.

(1-1. Production of Negative Electrode Layer)

12 g of carbon black as amorphous carbon, 2 g of silver particles as the first element, and 6 g of iron particles as the second element were put in a container, and an NMP solution in which 8 wt % of a binder (#9300, Kureha Corp.) was included was added thereto and then, stirred, while NMP was little by little added thereto, preparing a slurry-type negative electrode active material. The carbon black had a nitrogen adsorption specific surface area of 54 m²/g and a DBP oil absorption rate of 182 ml/100 g, the silver particles had a particle diameter of about 60 nm, and the iron particles had a particle diameter of 65 nm to 75 nm. This slurry type material for a negative electrode active material layer was coated on a 10 micron-thick stainless steel film with a blade coater, dried in the air at 80° C. for 20 minutes, and vacuum-dried at 100° C. for about 12 hours. In this way, on the negative electrode current collector made of a stainless steel foil, a negative electrode active material layer, which was a mixed particle thin film containing silver, iron, and carbon black, was formed, producing a negative electrode layer. This negative electrode layer had initial charge capacity of about 2 mAh.

(1-2 Production of All-solid-state Rechargeable Battery)

The negative electrode layer was used to produce an all-solid-state battery cell according to the following method. Li₆PS₅Cl, which is argyrodite type crystals, was used as a solid electrolyte. LiNi_{0.8}Co_{0.15}Mn_{0.05}O₂(NCM) as a positive active material, the Li₆PS₅Cl solid electrolyte, carbon nanofiber (CNF) as a conductive agent, TEFLON (tetrafluoroethylene) as a binder were mixed in a weight ratio of positive active material:solid electrolyte:CNF:binder=83:13.5:2:1.5 and then, made into a sheet for a positive active material layer. In addition, the sheet for a positive active material layer was molded into an about 2 cm square as an active material layer and then, pressed on an 18 μm-thick aluminum foil of a positive electrode current collector, producing a positive electrode layer. The positive electrode layer had initial charge capacity (charge capacity at the 1^{st} cycle) of about 18 mAh for 4.25 V charge. Accordingly, negative electrode capacity/positive electrode capacity was about 0.11, satisfying the requirements of Formula (1) described above.

Subsequently, a solid electrolyte sheet was produced according to the following method. 1 wt % of a binder was added to the Li₆PS₅Cl solid electrolyte and then, stirred, while xylene and diethylbenzene were added thereto, preparing a slurry-type solid electrolyte material. The obtained slurry-type solid electrolyte material was coated on a non-woven fabric using the blade coater, dried in the air at 40° C. and vacuum-dried at 40° C. for 12 hours, obtaining the solid electrolyte sheet.

The positive electrode layer, the solid electrolyte sheet, and the negative electrode layer were sequentially laminated and sealed in a laminate film under vacuum, producing an all-solid-state battery cell. A portion of each the positive electrode layer and the negative electrode layer was extended out of the laminate film, while being kept in the vacuum state, and used as a terminal through which the positive electrode layer or the negative electrode layer were electrically connected to an external wiring. This obtained all-solid-state rechargeable battery cell was subjected to hydrostatic pressure of 490 MPa. In addition, this all-solid-state battery was placed between two stainless steel plates with a thickness of about 1 cm at both sides of the laminating direction. Each of the two stainless steel plates had four holes in the same location, and the all-solid-state battery cell was be placed inside the quadrilateral made by the four holes. In this state, one bolt was passed through each of the four holes so as to penetrate the two stainless steel plates from the outside of the two stainless steel plates. Subsequently, while the two stainless steel plates were pressed from the outside, the four bolts were respectively closed and tightened with nuts, applying a pressure of about 4 MPa to the all-solid-state battery cell. Then, charge and discharge characteristics of the cell were evaluated under the following conditions.

(1-3. Evaluation of Charge/Discharge Characteristics)

The measurement was performed by putting the all-solid-state battery cell in a 25° C. thermostat. The charging was performed up to a battery voltage of 4.25 V at a constant current of 0.6 mA/cm² and then, to a current of 0.3 mA at a constant voltage of 4.25 V. The discharging was performed to a battery voltage of 2.5 V at a constant current 0.6 mA/cm², 2 mA/cm², and 6 mA/cm² in each first, second, and third cycles. In the first and third cycles, discharge capacity per active material weight (specific discharge capacity) was 185.7 mAh/g and 127.7 mAh/g, respectively. The results are shown in Table 1.

### Examples 2 and 3

All-solid-state rechargeable battery cells were produced in the same manner as in Example 1 except that the iron particles, the second element of the negative electrode active material, were respectively used in amounts of 2 g and 1 g, and then, charge and discharge characteristics thereof were evaluated in the same order as in Example 1. The results are shown in Table 1.

### Examples 4 and 5

All-solid-state rechargeable battery cells were produced in the same manner as in Example 1 except that the iron particles, the second element of the negative electrode active material, were adjusted to have a particle diameter of 800 nm and respectively used in amounts of 2 g and 6 g, and then, charge and discharge characteristics thereof were evaluated in the same order as in Example 1. The results are shown in Table 1.

### Examples 6 and 7

All-solid-state rechargeable battery cells were produced in the same manner as in Example 1 except that copper particles with a particle diameter of 70 nm were used instead of the iron particles, as the second element of the negative electrode active material, and respectively used in amounts of 2 g and 6 g, and then, charge and discharge characteristics thereof were evaluated in the same order as in Example 1. The results are shown in Table 1.

### Examples 8 and 9

All-solid-state rechargeable battery cells were produced in the same manner as in Example 1 except that titanium particles with a particle diameter of 70 nm were used instead of the iron particles, as the second element of the negative electrode active material, and respectively in amounts of 2 g and 6 g, and then, charge and discharge characteristics thereof were evaluated in the same order as in Example 1. The results are shown in Table 1.

### Comparative Example 1

An all-solid-state rechargeable battery cell was produced in the same manner as in Example 1, except that 2 g of silver particles with a particle diameter of 60 nm was used instead of the iron particles, as the second element of the negative electrode active material second element. In addition, 12 g of carbon black as amorphous carbon and 4 g of silver particles as the first element were mixed. Charge and discharge characteristics thereof were evaluated in the same manner as Example 1. As a result, discharge specific capacity at the first and third cycle was 178.4 mAh/g and 73.1 mAh/g, respectively. The results are shown in Table 1.

### Comparative Example 2

An all-solid-state rechargeable battery cell was produced in the same manner as

Example 1, except that 2 g of zinc particles with a particle diameter of 80 nm was used instead of the iron particles, as the second element of the negative electrode active material, and then, charge and discharge characteristics thereof were evaluated in the same order as Example 1. The results are shown in Table 1.

### Comparative Example 3

An all-solid-state rechargeable battery cell was produced in the same manner as

Example 1, except that 2 g of tin particles with a particle diameter of 60 nm to 80 nm was used instead of the iron particles, as the second element of the negative electrode active material, and then, charge and discharge characteristics thereof were evaluated in the same order as Example 1. The results are shown in Table 1.

### Comparative Example 4

An all-solid-state rechargeable battery cell was produced in the same manner as Example 1, except that 2 g of aluminum particles with a particle diameter of 40 nm to 50 nm was used instead of the iron particles, as the second element of the negative electrode active material, and then, charge and discharge characteristics thereof were evaluated in the same order as Example 1. The results are shown in Table 1.

### Comparative Example 5

An all-solid-state rechargeable battery cell was produced in the same manner as Example 1, except that 2 g of bismuth particles with a particle diameter of 40 nm to 60 nm was used instead of the iron particles, as the second element of the negative electrode active material, and then, charge and discharge characteristics thereof were evaluated in the same order as Example 1. The results are shown in Table 1.

### Comparative Example 6

An all-solid-state rechargeable battery cell was produced in the same manner as Example 1 except that the iron particles, as the second element of the negative electrode active material, were omitted, and then, charge and discharge characteristics thereof were evaluated in the same order as Example 1. As a result, discharge specific capacity at the first and third cycle was 179.0 mAh/g and 66.5 mAh/g, respectively. The results are shown in Table 1.

TABLE 1

| | | Particle | First cycle | Third cycle | |
|---|---|---|---|---|---|
| | | diameter of | discharge | Discharge | |
| | | second | specific | specific | |
| | | element | capacity | capacity | |
| | Negative electrode | (nm) | (mAh/g) | (mAh/g) | Effect |
| Example 1 | CB:Ag:Fe = 6/1/3 | 65 to 75 | 185.7 | 127.7 | ◯ |
| Example 2 | CB:Ag:Fe = 6/1/1 | 65 to 75 | 185.0 | 97.4 | ◯ |
| Example 3 | CB:Ag:Fe = 6/1/0.5 | 65 to 75 | 177.2 | 81.6 | ◯ |
| Example 4 | CB:Ag:Fe = 6/1/1 | 800 | 175.9 | 81.9 | ◯ |
| Example 5 | CB:Ag:Fe = 6/1/3 | 800 | 174.1 | 80.7 | ◯ |
| Example 6 | CB:Ag:Cu = 6/1/1 | 70 | 182.9 | 85.7 | ◯ |
| Example 7 | CB:Ag:Cu = 6/1/3 | 70 | 185.9 | 124.9 | ◯ |
| Example 8 | CB:Ag:Ti = 6/1/1 | 70 | 181.3 | 92.8 | ◯ |
| Example 9 | CB:Ag:Ti = 6/1/3 | 70 | 179.5 | 82.4 | ◯ |
| Comparative | CB:Ag = 3/1 | | 178.4 | 73.1 | |
| Example 1 | | | | | |
| Comparative | CB:Ag:Zn = 6/1/1 | 80 | 178.3 | 68.2 | X |
| Example 2 | | | | | |
| Comparative | CB:Ag:Sn = 6/1/1 | 60 to 80 | 178.9 | 73.5 | X |
| Example 3 | | | | | |
| Comparative | CB:Ag:Al = 6/1/1 | 40 to 50 | 175.7 | 68.8 | X |
| Example 4 | | | | | |
| Comparative | CB:Ag:Bi = 6/1/1 | 40 to 60 | 176.6 | 68.9 | X |
| Example 5 | | | | | |
| Comparative | CB:Ag = 6/1 | | 179.0 | 66.5 | |
| Example 6 | | | | | |

(2. Evaluation of Results)

The results of the Examples and the Comparative Examples are shown in Table 1. Referring to the results, it may be seen that each all-solid-state battery cell showed no significant difference in the discharge capacity of the first cycle, and did exhibit significant differences in the discharge capacity of the third cycle. The reason may be that the output characteristic difference in the third cycle tends to reliably appear due to the large current density during the third cycle discharge. Accordingly, the effects of the additive elements in the negative electrode active material were evaluated according to discharge capacity of the third cycle.

In Table 1, e.g., when a portion of the silver element, i.e., the first element, was substituted with the second element that does not form an alloy or a compound with lithium, when the discharge capacity was significantly greatly improved compared with Comparative Example 1, “Effective” was given (∘ in Table), and when equivalent or inferior, “Not Effective” was given (X in Table). “Significantly greatly improved” indicates that the discharge capacity of the third cycle was increased by 10% or more (greater than or equal to 80.4 mAh/g), compared with only the silver addition (Comparative Example 1).

Examples 1 to 9 all exhibited 80.4 mAh/g or more as the discharge capacity of the third cycle, which largely exceeded that of Comparative Example 1. In other words, compared with Comparative Example 1 containing amorphous carbon and the first element alone (e.g., omitting the second element) in the negative electrode active material layer material, Examples 1 to 9 (including the second element) exhibited excellent charge and discharge characteristics.

On the other hand, the effects of Comparative Examples 2 to 5 did not even reach that of Comparative Example 1. It may be seen there was a difference in the output characteristic improvement depending on a type or an amount of metal particles added as the second element. Referring to the Examples and the Comparative Examples in Table 1, there was no beneficial effect when zinc, tin, aluminum, or bismuth as the second element was included, and there was a beneficial effect when iron, copper, or titanium (e.g., an element belonging to the fourth period in the periodic table and also to Groups 3 to 11) was included. Examples 1 to 9 had a sufficient effect, compared with Comparative Example 6 in which the amount of silver, i.e., the first element, was simply reduced (e.g., relative to the amorphous carbon). Resultantly, Examples 1 to 9 exhibited improved discharge specific capacity in the third cycle by not reducing the content of the first element, but rather by adding the second element in the negative electrode active material.

In addition, Examples 1 to 5 exhibited an effect when the weight of iron was between 8.3% and 50% of that of carbon, and in addition, when the particles had a particle diameter of 800 nm or larger, there was a small but still measurable effect.

Referring to the result, compared with when only amorphous carbon and the first element were included in the material for a negative electrode active material layer, when a portion of the first element was substituted or replaced with the second element, which was inexpensive, charge and discharge characteristics of the all-solid-state rechargeable battery cell in which lithium was deposited in the negative electrode layer were significantly improved, while the reducing the cost of the all-solid-state rechargeable battery cell. In Examples 1 to 9, the same effect would be expected, even though a type or shape of the first element, a ratio of amorphous carbon and the first element, and the like were changed.

By way of summation and review, in some all-solid-state rechargeable batteries, the lithium deposited at a negative electrode may penetrate a solid electrolyte layer and grow in a branched shape, deteriorating battery capacity as well as causing a short circuit. Some all-solid-state rechargeable batteries may be capable of suppressing generation and growth of lithium dendrites in the solid electrolyte layer. When such an all-solid-state rechargeable battery uses an element forming an alloy or a compound with lithium as a negative electrode active material, the lithium may be intercalated in the negative electrode active material layer at the initial charge and, after exceeding the charge capacity of the negative electrode active material layer, may be deposited inside the negative electrode active material layer or the rear surface thereof (at a current collector). As a result, the generation or growth of lithium dendrites in the solid electrolyte layer may be suppressed, and the short circuit and the battery capacity deterioration may be suppressed.

A noble metal element such as silver may be particularly effective as an element for forming an alloy or compound with lithium included in the negative electrode active material layer. However, when a noble metal element is used for the negative electrode active material layer, the production cost of the all-solid-state rechargeable battery may become large. Accordingly, an embodiment may provide an all-solid-state rechargeable battery that reduces an amount of a noble metal element used when producing the negative electrode of an all-solid rechargeable battery using lithium deposited on the negative electrode layer as an active material by charging as much as possible, and thus reduces the cost as much as possible while reducing the cost of the solid electrolyte layer and suppressing the generation or growth of lithium dendrites.

According to an embodiment, the generation or growth of lithium dendrites in the solid electrolyte layer may be suppressed by further adding a second element that does not form an alloy with lithium to the negative electrode active material layer, and an all-solid-state rechargeable battery may have better performance than when only an element (e.g., a first element) that forms an alloy or compound with lithium such as silver is added.

Whether the element forms an alloy or compound with lithium according to the electrochemical reaction may be determined, e.g., by the following experiment. First, using a Li metal foil as a counter electrode and 10 mg of powder mixed with a powder of a target element and a powder of a solid electrolyte in a weight ratio of 1:1 as a working electrode, CC-CV charging may be performed from OCV (open voltage) to about 0.01 V. When the target element forms an alloy or compound with lithium, several hundred to several thousand capacity (mAh/g) may be observed per weight of the target element. On the other hand, when no alloy or compound is formed, almost no capacity may be observed.

According to the material for the negative electrode active material layer for an all-solid-state rechargeable battery configured in this way, the production cost of the all-solid-state rechargeable battery having the negative electrode active material layer formed using the material for the negative electrode active material layer may be reduced while also reducing the short circuit and improving output characteristics.

While reducing the production cost of the all-solid-state rechargeable battery, short circuit may be suppressed and capacity characteristics and output characteristics may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A material for a negative electrode active material layer, the material comprising:
amorphous carbon,
a first element that forms an alloy or compound with lithium by an electrochemical reaction, and
a second element that does not form an alloy or compound with lithium by an electrochemical reaction,
wherein the second element is an element belonging to the fourth period and Groups 3 to 11 of the periodic table.

2. The material as claimed in claim 1, wherein the second element is iron, copper, titanium, or nickel.

3. The material as claimed in claim 1, wherein the amorphous carbon is carbon black.

4. The material as claimed in claim 1, wherein the first element is silver, platinum, gold, or palladium.

5. The material as claimed in claim 1, wherein the first element is silver.

6. The material as claimed in claim 1, wherein, in the negative electrode active material layer, a content of the second element is greater than or equal to about 8 parts by weight and less than or equal to about 50 parts by weight, based on 100 parts by weight of the amorphous carbon.

7. The material as claimed in claim 1, wherein the material includes:
50 wt % to 90 wt % of the amorphous carbon,
5 wt % to 20 wt % of the first element, and
5 wt % to 40 wt % of the second element based on 100 wt % of the material.

8. The material as claimed in claim 1, wherein:
a weight ratio of the amorphous carbon to the first element is in a range of 5:1 to 7:1;
a weight ratio of the amorphous carbon to the second element is in a range of 1.5:1 to 15:1; or
a weight ratio of the first element to the second element is in a range of 1:4 to 3:1.

9. The material as claimed in claim 1, wherein an average particle size (D50) of the second element is in a range of 20 nm to 1,000 nm.

10. An all-solid-state rechargeable battery, comprising:
a positive electrode layer,
a negative electrode layer, and
a solid electrolyte layer,
wherein the negative electrode layer includes a negative electrode active material layer including the material for a negative electrode active material layer as claimed in claim 1.

11. The all-solid-state rechargeable battery as claimed in claim 10, wherein:
an initial charging capacity of the positive electrode layer and an initial charging capacity of the negative electrode layer satisfies the requirements of Formula (1):
0.01<b/a<0.5 [Formula (1)]
in Formula (1), a is the initial charging capacity, in mAh, of the positive electrode layer and b is the initial charging capacity, in mAh, of the negative electrode layer.

12. A charging method for an all-solid-state rechargeable battery, wherein the method includes charging the all-solid-state rechargeable battery as claimed in claim 11 beyond the initial charging capacity of the negative electrode layer.

13. The charging method as claimed in claim 12, wherein charging is performed in a range of about 2 times to about 100 times the initial charging capacity of the negative electrode layer.
